(19) United States
(12) Patent Application Publication
(10) Pub. No.: US 2025/0377005 A1
(43) Pub. Date: Dec. 11, 2025

(54) DOWEL PIN

(71) Applicant: Nathan Ray Dobbins, Apache Junction, AZ (US)

(72) Inventor: Nathan Ray Dobbins, Apache Junction, AZ (US)

(21) Appl. No.: 18/739,521

(22) Filed: Jun. 11, 2024

(51) Int. Cl. F16B 13/02

(52) U.S. Cl. CPC F16B 13/02

(57) ABSTRACT

A dowel pin is disclosed. The dowel pin has a central shaft, one or more fins, and at least one channel. The shaft includes a plurality of shaft sections having similar or different height and width dimensions. The one or more fins each have a fin length and a fin height, and extend outward from the shaft around discrete perimeters of the shaft. The one or more fins are spaced incrementally along the length of the shaft with even and uneven spacing. The at least one channel extends approximately an entire length of the shaft.

### FIELD

The present disclosure generally relates to the joining together of two members, and more particularly to a dowel pin having particular features.

### BACKGROUND

Dowels are commonly used as structural reinforcements or for joinder of components in cabinets, furniture, wheel axles in toys, and in various other mechanical components. Traditionally, dowel pins were made of wood, and were forced or hammered into corresponding holes of two members to align or join the members.

Variability in the sizing of the dowel pins impact how effective they are during use. If too small, a dowel pin may not be effectively retained in the holes or may not adequately retain or align the members. If too large, a dowel pin may cause the member to split around the hole.

Therefore, it would be desirable to optimize dowel size and shape to optimize a snug fit within the hole in each member to improve performance of the dowel pin without causing damage to the adjoining members.

### SUMMARY

A dowel pin, comprising a shaft having a plurality of shaft sections, wherein at least two of the plurality of shaft sections have different dimensions, one or more fins extending from the shaft in each of the plurality of shaft sections, and at least one channel extending through a plurality of the one or more fins.

A dowel pin, comprising a shaft having a plurality of shaft sections, one or more fins extending from the shaft in each of the plurality of shaft sections, wherein the one or more fins of each shaft section have different dimensions, and at least one channel extending through a plurality of the one or more fins.

A dowel pin, comprising a shaft having a plurality of shaft sections; one or more fins extending from the shaft in each of the plurality of shaft sections; and at least one channel extending through the entire length of the shaft.

### BRIEF DESCRIPTION OF THE DRAWINGS

Various aspects and advantages will become apparent upon review of the following detailed description and upon reference to the drawings in which:

FIG. 1 illustrates an isometric view of a dowel pin as taught in this disclosure;

FIG. 2 illustrates a side view of a dowel pin;

FIG. 3 illustrates an outline of a side view of a dowel pin;

FIG. 4 illustrates a cross-sectional side view of a dowel pin.

### DETAILED DESCRIPTION

The following disclosure includes an apparatus for a dowel pin used in the joinder of two abutting bodies. The dowel pin may have a central shaft, one or more fins, and at least one channel. The shaft may include a plurality of shaft sections which collectively extend the full length of the dowel pin. The shaft sections may vary in height and width dimensions. Where the shaft and/or the shaft sections are circular in cross-section, the height and width dimensions of the shaft and/or each respective shaft section may be equal. The height and width dimensions of each shaft section may be similar or different to the other shaft sections.

The one or more fins may each have a fin length and a fin height. The one or more fins may extend from the shaft around discrete perimeters of the shaft. The one or more fins may extend radially outward from shaft 110 (e.g., where the shaft is circular). The one or more fins may be spaced incrementally along the length of the shaft.

The at least one channel may extend along a portion of the length of the shaft, or along approximately an entire length of the shaft. The at least one channel may extend through the shaft with a channel height and channel width dimensions.

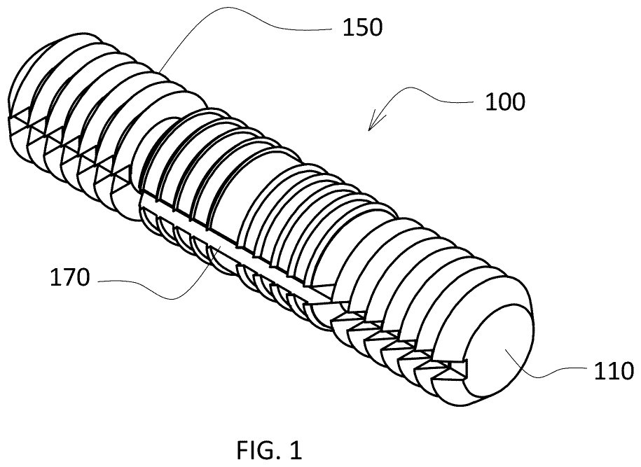

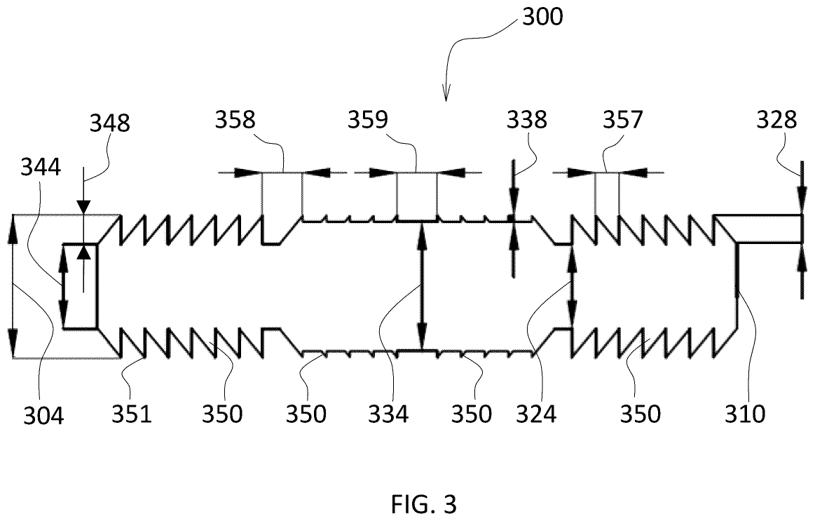

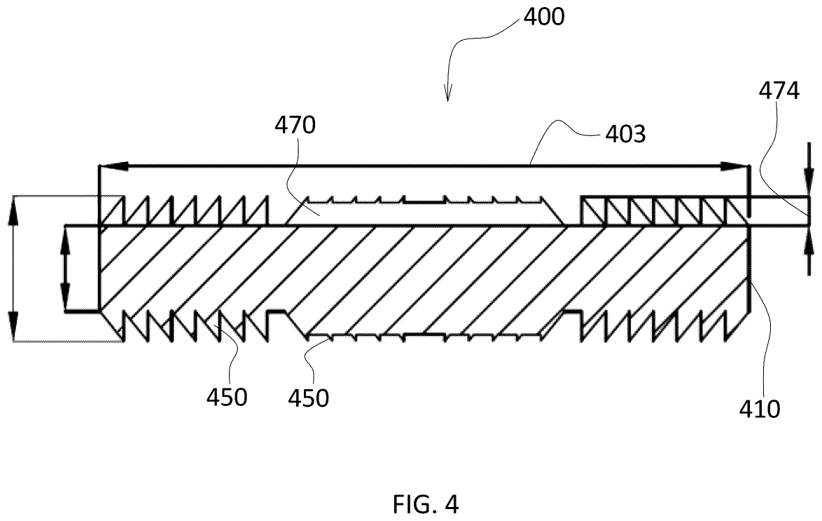

FIG. 1 illustrates a dowel pin 100 having a central shaft 110, one or more fins 150, and at least one channel 170. Dowel pin 100 may have a length (e.g., length 403 of FIG. 4). Dowel pin 100 may have a height and/or a width dimension (e.g., height 304 of FIG. 3). Where dowel pin 100 is circular in cross-section, the height and width dimensions may be equal (e.g., corresponding to a dowel diameter). Though dowel pin 100 is exemplified in FIG. 1 as having a circular cross-section, other cross-sectional shapes are contemplated by this disclosure (e.g., triangular, square, oval, rhomboid, rectangular, and so forth), wherein the height and width dimensions may not be equal.

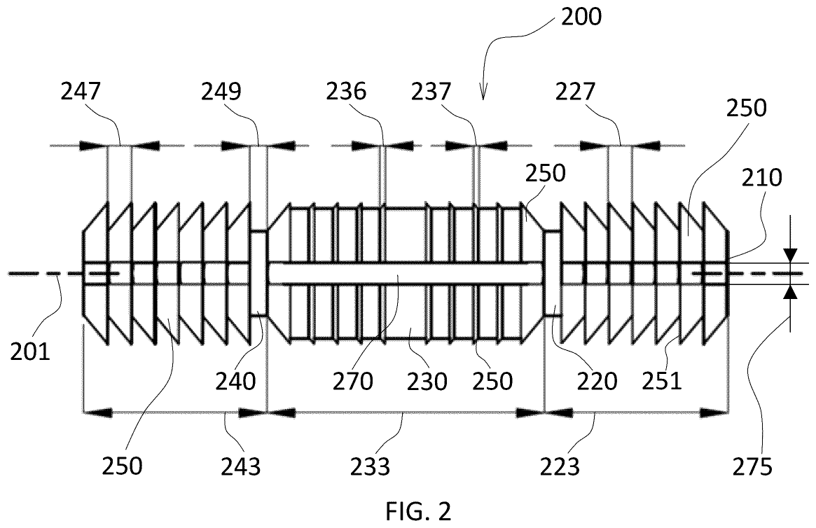

Shaft 110 may extend the full length of dowel pin 100. Shaft 110 may be composed of a plurality of shaft sections. Each shaft section may have a length dimension (e.g., shaft section lengths 223, 233, 243 of FIG. 2), and the shaft section lengths may collectively extend the full length of shaft 110. Shaft 110 may have one or more height and/or width dimensions corresponding to each shaft section (e.g., shaft section heights 324, 334, 344 of FIG. 3). Where shaft 110 is circular in cross-section, the height and width dimensions of each respective shaft section may be equal (e.g., corresponding to a shaft section diameter), though the height and width dimensions of each shaft section may be similar or different to the other shaft sections. Though shaft 110 is exemplified in FIG. 1 as having a circular cross-section, other cross-sectional shapes are contemplated by this disclosure. It is also contemplated that each shaft section may have a similar or different cross-sectional shape to the other shaft sections. A person of ordinary skill in the art will appreciate that different cross-sectional shapes may resist forces in a plurality of loading directions, and therefore a combination of shapes may provide better securement against movement of two abutting bodies during assembly and/or loading.

The one or more fins 150 may each have a length dimension (e.g., fin lengths 227, 236, 237, 247 of FIG. 2). The one or more fins 150 may have a relatively large fin length at shaft 110 (e.g., where the fin extends from each shaft section), and the fin length may narrow to a relatively narrow fin length as the one or more fins 150 extend away from shaft 110. The one or more fins 150 may have a first fin length at shaft 110 and a second fin length at a position away from shaft 110. The first dimension may be greater than or equal to the second dimension. The one or more fins 150 may have a constant fin length as they extend away from shaft 110. The one or more fins 150 may have include convex, flat, or concave surfaces. The fin length of each of the one or more fins 150 may be the same or different.

The one or more fins 150 may extend outwardly from shaft 110. Each fin 150 may extend radially outward from shaft 110. Each fin 150 may extend outwardly from shaft 110 around a perimeter formed by a cross-section extending along a plane perpendicular to the shaft length. Where the cross-section is circular, as exemplified in FIG. 1, the perimeter may form a circle. Where the perimeter is circular, each fin 150 may extend around shaft 110 to form a circular fin. The one or more fins 150 may have one or more height and/or width dimensions corresponding to each shaft section (e.g., fin heights 328, 338 of FIG. 3). Where shaft 110 is circular in cross-section, the height and width dimensions of the one or more fins 150 in each respective shaft section may be equal, though the height and width dimensions of each section of fins may be similar or different than in the other shaft sections. Though the one or more fins 150 are exemplified in FIG. 1 as having a circular shape, other shapes are contemplated by this disclosure, such that the fin height may be similar or different to the fin width. Fin dimensions may also vary as between each shaft section. A person of ordinary skill in the art will appreciate that different fin dimensions may allow lesser or greater deflection and/or resistance as the dowel pin is forced into corresponding apertures of abutting bodies, and therefore a combination of dimensions may provide better securement against movement of two abutting bodies during assembly and/or loading.

The one or more fins 150 may be spaced incrementally along the length of shaft 110 (e.g., having fin spacing 357, 358, 359 of FIG. 3). The one or more fins 150 may be spaced regularly or irregularly along the length of shaft 110, or both. The one or more fins 150 may be spaced evenly or unevenly along the length of shaft 110, or both. The one or more fins 150 may be spaced symmetrically or asymmetrically along the length of shaft 110, or both. The fin spacing may be greater than or equal to the fin length.

The at least one channel 170 may extend along a portion of the length of shaft 110. The at least one channel 170 may extend along the entire length of shaft 110, as exemplified in FIG. 1. The at least one channel 170 may have a height extending through at least a portion of the one or more fins 150. The at least one channel 170 may have a height extending entirely through the one or more fins 150. The at least one channel 170 may have a height extending through at least a portion of shaft 110 (e.g., channel height 474). The at least one channel 170 may have a width dimension extending perpendicular to the depth of channel 170 and/or perpendicular to the length of shaft 110 (e.g., channel width 275).

FIG. 2 illustrates a dowel pin 200 having a shaft 210, one or more fins 250, and a channel 270. Shaft 210 may include one or more shaft sections having similar and/or different dimensions. The one or more shaft sections may include a first shaft section 220, a second shaft section 230 and/or a third shaft section 240. Nevertheless, this disclosure contemplates fewer or greater numbers of shaft sections (e.g., 1, 2, 3, 4, 5, 6, or more shaft sections).

Each shaft section may have a shaft section length, a shaft section width and/or a shaft section height. The first shaft section 220 may have a first shaft section length 223 and a first shaft section height (e.g., first shaft section height 324 of FIG. 3). The second shaft section 230 may have a second shaft section length 233 and a second shaft section height (e.g., second shaft section height 334 of FIG. 3). The third shaft section 240 may have a third shaft section length 243 and a third shaft section height (e.g., third shaft section height 344 of FIG. 3). The first shaft section length 223 may be less than, equal to, or greater than the second shaft section length 233. The first shaft section length 223 may be less than, equal to, or greater than the third shaft section length 243. The second shaft section length 233 may be less than, equal to, or greater than the third shaft section length 243.

The one or more fins 250 may each have a length dimension. The fin length may vary throughout each shaft section and/or as between each shaft section. In FIG. 2, the first shaft section 220 is exemplified with a plurality of fins 250 each having a first fin length 227. The first fin length 227 narrows as the plurality of fins 250 extend away from the first shaft section 220. This narrowing is exemplified with a flat contours forming an acute angle at a tip 251 of each fin 250, though other contours are contemplated with this disclosure (e.g., such as rounded and/or beveled tips, or convex and/or concave contours). The second shaft section 230 is exemplified with a plurality of fins 250 each having a second fin length 236, 237 (e.g., where fin length 236 is equal to fin length 237). The second fin lengths 236, 237 likewise narrow as the plurality of fins 250 extend away from the second shaft section 230. The third shaft section 240 is exemplified with a plurality of fins 250 each having a third fin length 247. The third fin length 247 likewise narrows as the plurality of fins 250 extend away from the third shaft section 240.

The first fin length 227 may be less than, equal to, or greater than the second fin lengths 236, 237. The first fin length 227 may be less than, equal to, or greater than the third fin length 247. The second fin lengths 236, 237 may be less than, equal to, or greater than the third fin length 247. While FIG. 2 exemplifies the fin lengths in each shaft section as approximately of uniform dimension throughout each respective shaft section, this need not be the case, and this disclosure contemplates other arrangements.

The channel 270 may extend along the entire length of shaft 210, as exemplified in FIG. 2. Channel 270 may have a channel width 275 extending perpendicular to the depth of channel 170 and/or perpendicular to the length of shaft 110 (e.g., cutting through the one or more fins 250 and/or shaft 210). Channel 270 may be wide enough to allow the flow of air, fluid, and/or adhesive once dowel pin 200 has been forced into an aperture of one or more abutting bodies. Channel 270 may be narrow enough to maximize the degree to which surface area of the one or more fins 250 contact an interior surface of the aperture, which may maximize the frictional fit of the dowel pin 200. Channel 270 may be centered across a central axis 201 of dowel pin 200, as exemplified in FIG. 2 (e.g., extending into the one or more fins 250 and/or shaft 210 in a direction extending through central axis 201). Channel 270 may be offset from the central axis 201 (e.g., extending at an angle such that the direction of channel 270 would not intersect with central axis 201).

While the first shaft section 220 of dowel pin 200 is exemplified having seven fins, this disclosure contemplates fewer or greater numbers of fins (e.g., 1, 2, 3, 4, 5, 6, 7, 8, 9, 10, or more fins). While the second shaft section 230 of dowel pin 200 is exemplified having ten fins, this disclosure contemplates fewer or greater numbers of fins (e.g., 1, 2, 3, 4, 5, 6, 7, 8, 9, 10, 11, 12, 13, 14, 15, 16, 17, 18, or more fins). While the third shaft section 240 of dowel pin 200 is exemplified having seven fins, this disclosure contemplates fewer or greater numbers of fins (e.g., 1, 2, 3, 4, 5, 6, 7, 8, 9, 10, or more fins). The number of fins in the first shaft section 220 may be less than, equal to, or greater than the number of fins in the second shaft section 230. The number of fins in the first shaft section 220 may be less than, equal to, or greater than the number of fins in the third shaft section 240. The number of fins in the second shaft section 230 may be less than, equal to, or greater than the number of fins in the third shaft section 240.

Each shaft section may have a part and/or portion without any fins. FIG. 2 exemplifies a dowel pin 200 wherein every shaft section has portions without fins (e.g., the surface area existing in length portion 249 of third shaft section 240). Nevertheless, each shaft section may have any number of length portions (e.g., 0, 1, 2, 3, 4, 5, 6, 7, 8, 9, 10, 11, 12, 13, 14, 15, 16, or more length sections without fins). A person of ordinary skill in the art will appreciate that the number of fins and the number of length portions without fins may be optimized to maximize retention of two or more abutting bodies.

FIG. 3 illustrates an outline of a dowel pin 300 having a shaft 310 and one or more fins 350. Dowel pin 300 may not include a channel. Shaft 310 may include one or more shaft sections having similar and/or different dimensions (e.g., shaft sections 220, 230, 240 of FIG. 2). Each shaft section may have a shaft section length, a shaft section width and/or a shaft section height. A first shaft section may have a first shaft section length (e.g., first shaft section length 223 of FIG. 2) and a first shaft section height 324. A second shaft section may have a second shaft section length (e.g., second shaft section length 233 of FIG. 2) and a second shaft section height 334. A third shaft section may have a third shaft section length (e.g., third shaft section length 243 of FIG. 2) and a third shaft section height 344. The first shaft section height 324 may be less than or equal to the second shaft section height 334. The first shaft section height 324 may be less than, equal to, or greater than the third shaft section height 344. The second shaft section height 334 may be greater than or equal to the third shaft section height 344.

The one or more fins 350 may extend outwardly from shaft 310 (e.g., from each shaft section). The one or more fins 350 may have one or more height and/or width dimensions. The fin height and/or width may vary throughout each shaft section and/or as between each shaft section. In FIG. 3, the first shaft section is exemplified with a plurality of fins 350 each having a first fin height 328. The second shaft section is exemplified with a plurality of fins 350 each having a second fin height 338. The third shaft section is exemplified with a plurality of fins 350 each having a third fin height 348.

The first fin height 328 may be greater than or equal to the second fin height 338. The first fin height 328 may be less than, equal to, or greater than the third fin height 348. The second fin height 338 may be less than or equal to the third fin height 348. While FIG. 3 exemplifies the fin heights in each shaft section as approximately of uniform dimension throughout each respective shaft section, this need not be the case, and this disclosure contemplates other arrangements.

The one or more fins 350 may be spaced incrementally along the length of shaft 310. Fin spacing may be determined by the length dimension from one fin tip 351 to the next adjacent fin tip 351. At least two fins may have a first fin spacing 357. First fin spacing 357 may correspond to a fin length (e.g., fin lengths 227, 247 of FIG. 2). At least two fins may have a second fin spacing 358. Second fin spacing 358 may represent the spacing between adjacent fin tips 351 in two adjoining shaft sections. At least two fins may have a third fin spacing 359. Third fin spacing 359 may represent the spacing between adjacent fin tips 351 in a common shaft section. Thus, a combination of one or more fins 350 having first fin spacing 357, second fin spacing 358, and third fin spacing 359 may produce a dowel pin 300 with any combination of fins 350 and fin spacing.

This disclosure describes the fins as having flat contours forming an acute angle at the fin tip 351. It is understood that this description may describe features evident in a cross-section, since the two-dimensional “flat contours” may be represented in three dimensions by surfaces extending around a perimeter of shaft 310 (e.g., flat surfaces and curved surfaces). Furthermore, the two-dimensional “fin tip” may be represented in three dimensions by a line extending around the perimeter of shaft 310 (e.g., a flat and/or curved line, depending on the cross-section of shaft 310). The sloping of the flat and/or curved surfaces may be structured in such a way that the one or more fins 350 appear to lean in one direction or another. For example, shaft 310 may have a midpoint along its length (e.g., a midpoint along length 403 of FIG. 4). The one or more fins 350 may lean toward the midpoint of the length of shaft 310 (e.g., inward). This disclosure also contemplates configurations where the one or more fins 350 may lean inward toward some other position along the length of shaft 310 (e.g., any discrete position between opposing ends of shaft 310). A person of ordinary skill in the art will appreciate that the position to which the inward lean extends and the angle of lean of each of the one or more fins 350 may be optimized to account for different material properties and/or dimensions of abutting bodies, which may improve retention of the bodies.

FIG. 3 exemplifies one embodiment of the dowel pin 300 wherein the height 304 of dowel pin 300 represents the maximum height of all shapes and contours of dowel pin 300. The first shaft section height 324, when combined with the first fin height 328 extending both above and below the first shaft section may collectively add up to height 304. The second shaft section height 334, when combined with the second fin height 338 extending both above and below the second shaft section may collectively add up to height 304. The third shaft section height 344, when combined with the third fin height 348 extending both above and below the third shaft section may collectively add up to height 304. Thus, height 304 of dowel pin 300 represents a maximum height of dowel pin 300 in each shaft section. This disclosure contemplates other combinations of shaft section heights and fin heights in each shaft section, such that the combined height in each shaft section may be similar and/or different. As the combinations are too great to number, each combination will not be explicitly described here, nevertheless, a person of ordinary skill in the art will appreciate that each shaft section may be customized to optimize retention of dowel pin 300 within two or more abutting bodies.

FIG. 4 illustrates a cross-sectional side view of a dowel pin 400 having a shaft 410, one or more fins 450, and a channel 470. The channel 470 may extend along the entire length of shaft 410, as exemplified in FIG. 4 (e.g., having a length corresponding to length 403). Channel 470 may have a height extending through at least a portion of the one or more fins 450. Channel 470 may have a height extending entirely through the one or more fins 450. Channel 470 may have a height extending through the one or more fins 450 and may further extend through at least a portion of shaft 410 (e.g., channel height 474). Channel height 474 may be tall enough to allow the flow of air, fluid, and/or adhesive once dowel pin 200 has been forced into an aperture of one or more abutting bodies. Channel 270 may be short enough to prevent excessive flow of fluid out of channel 270 (e.g., allowing adhesive to cure before it runs out of an aperture into which dowel pin 400 has been placed).

Other aspects will be apparent to those skilled in the art from consideration of the specification and practice disclosed herein. It is intended, therefore, that the specification and illustrated figures be considered as examples only.

What is claimed is:

1. A dowel pin, comprising:
a shaft having a plurality of shaft sections, wherein at least two of the plurality of shaft sections have different dimensions; and
one or more fins extending from the shaft in each of the plurality of shaft sections.

2. The dowel pin of claim 1, wherein the at least two of the plurality of shaft sections have different width or height dimensions.

3. The dowel pin of claim 1, wherein the one or more fins of each shaft section have different dimensions.

4. The dowel pin of claim 1, wherein the dowel pin further includes at least one channel extending through the entire length of the shaft.

5. The dowel pin of claim 1, wherein the plurality of shaft sections includes a first shaft section, a second shaft section, and a third shaft section, wherein the shaft sections collectively extend the entire length of the shaft.

6. The dowel pin of claim 5, wherein the second shaft section has a height dimension that is greater than a height dimension of the first shaft section, and wherein the second shaft section has a height dimension that is greater than a height dimension of the third shaft section.

7. A dowel pin, comprising:
a shaft having a plurality of shaft sections, wherein at least two of the plurality of shaft sections have different dimensions;
one or more fins extending from the shaft in each of the plurality of shaft sections, wherein the one or more fins of each shaft section have different dimensions; and
at least one channel extending through a plurality of the one or more fins.

8. The dowel pin of claim 7, wherein the at least one channel extends through the entire length of the shaft.

9. The dowel pin of claim 7, wherein at least two of the plurality of shaft sections have different width or height dimensions.

10. The dowel pin of claim 7, wherein the plurality of shaft sections includes a first shaft section, a second shaft section, and a third shaft section, wherein the shaft sections collectively extend the entire length of the shaft.

11. The dowel pin of claim 10, wherein the first shaft section has a height dimension that is less than a height dimension of the second shaft section, and wherein the third shaft section has a height dimension that is less than a height dimension of the second shaft section.

12. The dowel pin of claim 10, wherein the one or more fins of the second shaft section have a height dimension that is less than a height dimension of the one or more fins of the first shaft section, and wherein the one or more fins of the second shaft section have a height dimension that is less than a height dimension of the one or more fins of the third shaft section.

13. A dowel pin, comprising:
a shaft having a plurality of shaft sections, wherein at least two of the plurality of shaft sections have different dimensions;
one or more fins extending from the shaft in each of the plurality of shaft sections; and
at least one channel extending through the entire length of the shaft.

14. The dowel pin of claim 13, wherein at least two of the plurality of shaft sections have different width or height dimensions.

15. The dowel pin of claim 13, wherein the one or more fins of each shaft section have different dimensions.

16. The dowel pin of claim 13, wherein the plurality of shaft sections includes a first shaft section, a second shaft section, and a third shaft section, wherein the shaft sections collectively extend the entire length of the shaft.

17. The dowel pin of claim 16, wherein the first shaft section has a height dimension that is less than a height dimension of the second shaft section, and wherein the third shaft section has a height dimension that is less than a height dimension of the second shaft section.

18. The dowel pin of claim 16, wherein the second shaft section has a height dimension that is greater than a height dimension of the first shaft section, and wherein the second shaft section has a height dimension that is greater than a height dimension of the third shaft section.

18. The dowel pin of claim 16, wherein the one or more fins of the second shaft section have a height dimension that is less than a height dimension of the one or more fins of the first shaft section, and wherein the one or more fins of the second shaft section have a height dimension that is less than a height dimension of the one or more fins of the third shaft section.

20. The dowel pin of claim 16, further including:
wherein the second shaft section has a second shaft section height that is greater than a first shaft section height of the first shaft section;
wherein the second shaft section height is greater than a third shaft section height of the third shaft section;
wherein the one or more fins of the second shaft section have a second fin height that is less than a first fin height of the one or more fins of the first shaft section;
wherein the second fin height is less than a third fin height of the one or more fins of the third shaft section;
wherein the shaft sections are arranged in the order first shaft section, second shaft section, third shaft section;
wherein the second shaft section height plus two times the second fin height is equal to the first shaft section height plus two times the first fin height; and
wherein the second shaft section height plus two times the second fin height is equal to the third shaft section height plus two times the third fin height.
